(19) United States
(12) Patent Application Publication
(10) Pub. No.: US 2023/0307619 A1
(43) Pub. Date: Sep. 28, 2023

(54) NEGATIVE ACTIVE MATERIAL COMPOSITE FOR RECHARGEABLE LITHIUM BATTERY, METHOD OF PREPARING THE SAME, NEGATIVE ELECTRODE INCLUDING THE SAME AND RECHARGEABLE LITHIUM BATTERY INCLUDING THE SAME

(71) Applicant: SAMSUNG SDI CO., LTD., Yongin-si (KR)

(72) Inventors: Jongmin WON, Yongin-si (KR); Youngugk KIM, Yongin-si (KR); Young-Min KIM, Yongin-si (KR); Sunil PARK, Yongin-si (KR); Jaehou NAH, Yongin-si (KR); Eunji KANG, Yongin-si (KR); Doori OH, Yongin-si (KR); Dae-Hyeok LEE, Yongin-si (KR); Changsu SHIN, Yongin-si (KR)

(21) Appl. No.: 17/969,035

(22) Filed: Oct. 19, 2022

(30) Foreign Application Priority Data
Mar. 22, 2022 (KR) 10-2022-0035510

(51) Int. Cl. H01M 4/38; H01M 4/583; H01M 4/04; H01M 4/58; H01M 4/36; H01M 10/052

(52) U.S. Cl. CPC H01M 4/386; H01M 4/583; H01M 4/0471; H01M 4/0404; H01M 4/0419; H01M 4/5825; H01M 4/364; H01M 10/052; H01M 2004/021

(57) ABSTRACT

A negative active material composite, a method of preparing the same, a negative electrode, and a rechargeable lithium battery including the same, the negative active material composite including silicon nanoparticles; amorphous carbon; and graphitized carbon.

### CROSS-REFERENCE TO RELATED APPLICATION

This application claims priority to and the benefit of Korean Patent Application No. 10-2022-0035510 filed in the Korean Intellectual Property Office on Mar. 22, 2022, the entire contents of which are incorporated herein by reference.

### BACKGROUND OF THE INVENTION

### 1. Field

Embodiments relate to a negative active material composite, a method of preparing the same, a negative electrode including the same, and a rechargeable lithium battery.

### 2. Description of the Related Art

Rechargeable lithium batteries are in the spotlight as power sources for driving medium to large devices such as hybrid vehicles and battery vehicles as well as small devices such as mobile phones, notebook computers, and smart phones.

As a negative active material for a rechargeable lithium battery, various types of carbon negative active materials including artificial graphite, natural graphite, hard carbon, or the like, capable of intercalating/deintercalating lithium ions, may be used. Recently, research on non-carbon negative active materials such as silicon and tin to obtain higher capacity has been considered.

### SUMMARY

The embodiments may be realized by providing a negative active material composite for a rechargeable lithium battery, the negative active material composite including silicon nanoparticles; amorphous carbon; and graphitized carbon.

The graphitized carbon may include 2 to 20 layers of graphene.

The graphitized carbon may be converted from a portion of the amorphous carbon, and the graphitized carbon may be distributed on a surface of the amorphous carbon, an inside of the amorphous carbon, or both the surface and the inside of the amorphous carbon.

the negative active material composite may further include a catalyst.

The catalyst may be iron (III) nitrate, nickel (II) nitrate, or a combination thereof.

The catalyst may have an average particle diameter (D50) of greater than 0 nm and less than or equal to about 150 nm.

The silicon nanoparticles may have an average particle diameter (D50) of about 50 nm to about 200 nm.

The silicon nanoparticles may have an aspect ratio of about 5 to about 20.

In an X-ray diffraction analysis using CuKα ray, a full width at half maximum of an X-ray diffraction angle (2θ) at the (111) plane of the silicon nanoparticles may be about 0.3° to about 9°.

When analyzing a Raman shift using a photon energy difference, the negative active material composite may satisfy Equation 1:

2.7≤A_{D}/A_{G}≤5 [Equation 1]

in Equation 1, A_{D} denotes an integral area in the disordered peak, 1350 cm⁻¹ to 1360 cm⁻¹, of the graphitized carbon; and A_{G} denotes an integral area at the alignment peak, 1580 cm⁻¹ to 1590 cm⁻¹, of the graphitized carbon.

The amorphous carbon may include soft carbon, hard carbon, a mesophase pitch carbonized product, calcined coke, or a mixture thereof.

The negative active material composite may include about 80 to 250 parts by weight of the silicon nanoparticles, based on 1 part by weight of the graphitized carbon.

The negative active material composite may include about 25 to 150 parts by weight of the amorphous carbon, based on 1 part by weight of the graphitized carbon.

The negative active material composite may include about 0.1 wt % to about 1 wt % of the graphitized carbon, and about 35 wt % to about 85 wt % of the silicon nanoparticles, all wt % being based on a total weight of the negative active material composite.

An average particle diameter (D50) of the negative active material composite may be about 2 μm to about 15 μm.

The negative active material composite may include a matrix including the amorphous carbon; the silicon nanoparticles inside the matrix; and the graphitized carbon distributed on a surface of the matrix, inside of the matrix, or both on the surface and inside of the matrix.

The embodiments may be realized by providing a method of preparing a negative active material composite for a rechargeable lithium battery, the method including spray-drying a slurry including a solvent, a catalyst, and silicon nanoparticles; and heat-treating a mixture including the obtained product of the spray-drying and an amorphous carbon precursor to obtain a negative active material.

The embodiments may be realized by providing a negative electrode for a rechargeable lithium battery, the negative electrode including a current collector; and a negative active material layer on the current collector, wherein the negative active material layer includes the negative active material composite according to an embodiment.

The negative active material layer may further include a conductive material, a binder, a negative active material that is different from the negative active material composite, or a combination thereof.

The embodiments may be realized by providing a rechargeable lithium battery including a positive electrode; a negative electrode; and an electrolyte, wherein the negative electrode is the negative electrode according to an embodiment.

### BRIEF DESCRIPTION OF THE DRAWINGS

Features will be apparent to those of skill in the art by describing in detail exemplary embodiments with reference to the attached drawings in which:

FIG. 1 is a schematic view of a negative active material composite according to an embodiment.

FIG. 2 is a perspective view of a pouch-type rechargeable battery according to an embodiment.

FIG. 3 is a vertical cross-sectional view taken along the line I-I in FIG. 2 in the arrow direction.

FIG. 4 is a horizontal cross-sectional view taken along the line II-II in FIG. 2 in the arrow direction.

FIG. 5 is a cycle-life slope evaluation result for each rechargeable lithium battery cell according to Example 1 and Comparative Example 1.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or element, it can be directly on the other layer or element, or intervening layers may also be present. In addition, it will also be understood that when a layer is referred to as being “between” two layers, it can be the only layer between the two layers, or one or more intervening layers may also be present. Like reference numerals refer to like elements throughout. As used herein, the term “or” is not an exclusive term, e.g., “A or B” would include A, B, or A and B.

The terminology used herein is used to describe embodiments only, and is not intended to limit the present disclosure. The singular expression includes the plural expression unless the context clearly dictates otherwise.

As used herein, “a combination thereof” refers to a mixture, a laminate, a composite, a copolymer, an alloy, a blend, a reaction product, and the like of constituents.

Herein, it should be understood that terms such as “comprises,” “includes,” or “have” are intended to designate the presence of an embodied feature, number, step, element, or a combination thereof, but it does not preclude the possibility of the presence or addition of one or more other features, number, step, element, or a combination thereof.

In addition, “layer” herein includes not only a shape formed on the whole surface when viewed from a plan view, but also a shape formed on a partial surface.

In addition, the “particle diameter” or “average particle diameter” may be measured by a method well known to those skilled in the art, for example, may be measured by a particle size analyzer, or may be measured by a transmission electron micrograph or a scanning electron micrograph. Alternatively, it is possible to obtain an average particle diameter value by measuring using a dynamic light scattering method, performing data analysis, counting the number of particles for each particle size range, and calculating from this. Unless otherwise defined, the average particle diameter may mean the diameter (D50) of particles having a cumulative volume of 50 volume % in the particle size distribution.

“Thickness” may be measured through a picture taken with an optical microscope such as a scanning electron microscope.

“Peak intensity of the Raman spectrum” may be measured using a laser having a wavelength of about 514 nm or a laser having a wavelength of about 785 nm unless otherwise specified. For example, according to an embodiment, it may be measured using a laser having a wavelength of about 785 nm. Interpretation of such a Raman spectrum may be generally classified as a height ratio (intensity ratio) or an integral area ratio of peaks obtained from the Raman spectrum, and in an embodiment of the present invention, it means an integral area ratio.

(Negative Active Material)

An embodiment provides a negative active material composite for a rechargeable lithium battery including, e.g., silicon nanoparticles; amorphous carbon; and graphitized carbon.

In some other batteries, a mixture of graphite and silicon may be used in order to secure long-term cycle-life characteristics by suppressing a volume change of a non-carbon negative active material (silicon, tin, or the like) as well as improve low capacity of a carbon negative active material (artificial graphite, natural graphite, hard carbon, or the like).

The mixture of graphite and silicon could a limitation in suppressing the volume change of silicon and could cause a sharp decline in an initial cycle-life of a rechargeable lithium battery. When the volume change of silicon occurs during the initial driving process of the rechargeable lithium battery, a contact area between a negative active material layer including the mixture of graphite and silicon with a negative current collector could be reduced (i.e., the negative active material layer could be detached from the negative current collector), sharply deteriorating discharge capacity of the rechargeable lithium battery.

Increasing contents of a binder, a conductive material, or the like in a negative electrode, forming cracks on the surface of silicon, or the like have been considered. These methods could increase a price of the negative active material or deteriorate initial efficiency and cycle-life of the rechargeable lithium battery, which turns out an incomplete solution. As such, the capacity, initial efficiency, and long-term cycle-life of the rechargeable lithium battery could be in a trade-off relationship and thus difficult to evenly increase together.

In an embodiment, instead of the mixture of graphite and silicon, a negative active material composite for a rechargeable lithium battery may include, e.g., silicon nanoparticles; amorphous carbon; and graphitized carbon.

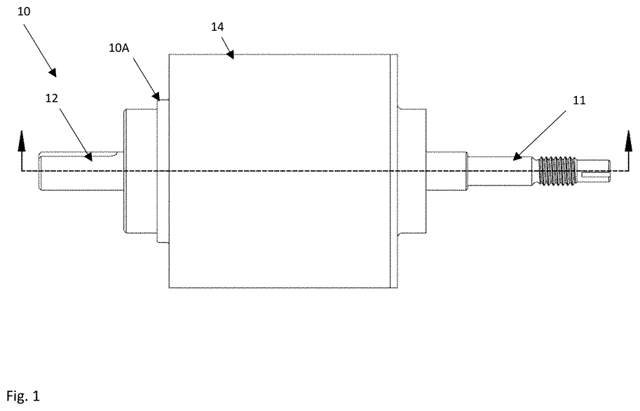

FIG. 1 is a schematic view of the negative active material composite according to an embodiment. In an implementation, the negative active material composite 200 may include the silicon nanoparticles 1 and the amorphous carbon 2 and thereby, may help suppress a volume change of the silicon nanoparticles 1 and thus improve long-term cycle-life characteristics as well as improve low capacity of the amorphous carbon.

In an implementation, the negative active material composite 200 according to an embodiment may further include the graphitized carbon 3 and may help improve adherence between the silicon nanoparticles 1 and the amorphous carbon 2, between the negative active material composite 200 and a negative current collector, and the like and resultantly, may help suppress reduction of a contact area of the negative active material layer including the negative active material composite 200 according to an embodiment with the negative current collector during the initial driving process of the rechargeable lithium battery and ultimately, prevent a sharp decline in an initial cycle-life of the rechargeable lithium battery. In an implementation, the graphitized carbon 3 may have high conductivity and thus may help improve a conductive network of the negative active material layer including the negative active material composite 200 according to an embodiment and may help increase an initial efficiency of the rechargeable lithium battery.

The negative active material composite according to an embodiment may help prevent the sharp decline in an initial cycle-life of the rechargeable lithium battery and simultaneously, secure capacity, initial efficiency, long-term cycle-life, and the like. Hereinafter, the negative active material composite of the embodiment is described in detail.

Silicon Nanoparticles

In the negative active material composite of the embodiment, the silicon nanoparticles may contribute to increasing the capacity of the rechargeable lithium battery.

The average particle diameter (D50) of the silicon nanoparticles may be, e.g., less than or equal to about 200 nm and greater than about 0 nm. In an implementation, the maximum particle diameter (Dₘₐₓ) may be, e.g., less than or equal to about 300 nm and greater than about 0 nm. In an implementation, the average particle diameter (D50) of the silicon nanoparticles may be, e.g., greater than or equal to about 50 nm, greater than or equal to about 70 nm, or greater than or equal to about 90 nm, and less than or equal to about 200 nm, less than or equal to about 150 nm, less than or equal to about 130 nm, or less than or equal to about 110 nm. In an implementation, the maximum particle diameter (Dₘₐₓ) of the silicon nanoparticles may be, e.g., greater than or equal to about 80 nm, greater than or equal to about 90 nm, greater than or equal to about 100 nm, or greater than or equal to about 110 nm, and less than or equal to about 300 nm, less than or equal to about 250 nm, less than or equal to about 240 nm, less than or equal to about 230 nm, or less than or equal to about 215 nm. Within these ranges, a side reaction between the silicon nanoparticles and the electrolyte may be suppressed, and expansion of the silicon nanoparticles may be reduced, thereby improving initial efficiency and cycle-life characteristics of the rechargeable lithium battery.

A short axis length (a) of the silicon nanoparticles may be, e.g., about 5 nm to about 50 nm, and a long axis length (b) of the silicon nanoparticles may be, e.g., about 50 nm to about 300 nm. An aspect ratio (b/a) of the silicon nanoparticles may be, e.g., about 5 to about 20. In an implementation, the aspect ratio of the silicon nanoparticles may be, e.g., greater than or equal to about 5, greater than or equal to about 6, or greater than or equal to about 7, and less than or equal to about 20, less than or equal to about 18, less than or equal to about 16, or less than or equal to about 14. When the long axis length (b), short axis length (a), and aspect ratio (b/a) of the silicon nanoparticles each fall within the above ranges, side reactions between the silicon nanoparticles and the electrolyte may be suppressed, and the expansion of the silicon nanoparticles may be reduced, so that initial efficiency and cycle-life characteristics of the rechargeable lithium battery may be improved.

A full width at half maximum of an X-ray diffraction angle (2theta) using CuKα ray at the (111) plane of the silicon nanoparticles may be, e.g., about 0.3° to about 9°, or specifically, about 0.41° to about 0.85°. Within these ranges, cycle-life characteristics of the rechargeable lithium battery may be improved. The full width at half maximum of the X-ray diffraction angle (2theta) using CuKα ray at the (111) plane of the silicon nanoparticles may be achieved by adjusting the particle size of the silicon nanoparticles or changing the silicon nanoparticle preparing process.

Amorphous Carbon and Graphitized Carbon

In the negative active material composite of the embodiment, the amorphous carbon may surround the outer surface of the silicon nanoparticles, so that the conductivity of the negative active material may be further improved, and contacts between the silicon nanoparticles and the electrolyte may be suppressed to reduce side reactions between them, and long-term cycle-life characteristics of the rechargeable lithium battery may be secured. In an implementation, the amorphous carbon may serve as a binder for binding the silicon nanoparticles to each other, thereby preventing the composite from breaking and maintaining its shape well.

The amorphous carbon may include, e.g., soft carbon, hard carbon, a mesophase pitch carbonized product, calcined coke, or a combination thereof. The amorphous carbon, in contrast to crystalline carbon, may effectively penetrate between silicon nanoparticles during the heat-treating process to help reduce internal pores, thereby improving conductivity and effectively suppressing side reactions of the electrolyte.

In an implementation, the amorphous carbon, unlike crystalline carbon, may be a precursor of graphitized carbon. Accordingly, a portion of the amorphous carbon may be a precursor of the graphitized carbon.

The graphitized carbon may include graphitized carbon converted from a precursor of graphitized carbon, graphitized carbon converted from a dispersant, or both. The graphitized carbon may have a structure close to graphite, but may have a structure different from that of artificial graphite.

As mentioned above, a portion of the amorphous carbon may be a precursor of the graphitized carbon. The conversion from a portion of the amorphous carbon to the graphitized carbon may be due to the presence of a catalyst.

As will be described in more detail below, when a mixture including the silicon nanoparticles and amorphous carbon precursor is heat treated, the silicon nanoparticles and amorphous carbon precursor (e.g., petroleum pitch, or the like) may be combined, and the amorphous carbon precursor may be converted to amorphous carbon. In an implementation, a portion of the amorphous carbon may be converted to graphitized carbon including graphene of, e.g., 2 to 20 layers, 2 to 15 layers, or 2 to 10 layers, and distributed on the surface of the amorphous carbon, inside of the amorphous carbon, or both on the surface and inside of the amorphous carbon.

The graphitized carbon converted from a portion of the amorphous carbon may include, e.g., 2 to 20 layers, 2 to 15 layers, or 2 to 10 layers of graphene, and may be distributed on the surface of the amorphous carbon, inside of the amorphous carbon, or both on the surface and inside of the amorphous carbon.

In an implementation, in the process of preparing the mixture including the silicon nanoparticles and amorphous carbon precursor, a dispersant such as stearic acid may be used, and the stearic acid may function as a dispersant and a precursor of graphitized carbon. In an implementation, when the mixture including the stearic acid, silicon nanoparticles, and amorphous carbon precursor is heat treated, the graphitized carbon converted from the stearic acid may also be distributed on the surface, inside, or both, of the amorphous carbon.

When the negative active material composite is analyzed through a Raman shift using a photon energy difference, peaks due to graphitized carbon in the negative active material composite may appear. In an implementation, when analyzing a Raman shift using a photon energy difference, the negative active material composite may exhibit a D peak (1,350 cm⁻¹ to 1,360 cm⁻¹) as a disordered peak of the graphitized carbon and a G peak (1,580 cm⁻¹ to 1,590 cm⁻¹) as an alignment peak of the graphitized carbon. In an implementation, the Raman spectrum may be measured using a laser having a wavelength of 514 nm or a laser having a wavelength of about 785 nm, and the result of the analysis may satisfy Equation 1.

2.7≤A_{D}/A_{G}≤5 [Equation 1]

In Equation 1, A_{D} denotes an integral area in the disordered peak (1,350 cm⁻¹ to 1,360 cm⁻¹) of the graphitized carbon; and A_{G} denotes an integral area at the alignment peak (1,580 cm⁻¹ to 1,590 cm⁻¹) of the graphitized carbon.

A_{D}/A_{G} of Equation 1 is an intensity ratio of the peak intensity (Id) of the D peak (1,350 cm⁻¹ to 1,360 cm⁻¹) to the peak intensity (Ig) of the G peak (1,580 cm⁻¹ to 1,590 cm⁻¹) (R=Id/Ig).

A lower limit of Equation 1 may be, e.g., about 2.7, about 2.9, about 3.1, or about 3.15, and an upper limit may be, e.g., about 5, about 4.7, about 4.5, about 4.3, or about 4.35. Within these ranges, by reducing the powder resistance, initial cycle characteristics may be increased, or rate capability may be increased.

Catalyst

The catalyst may be a material that participates in a reaction in which a portion of the amorphous carbon is converted into the graphitized carbon and contributes to increasing a reaction rate.

In an implementation, the catalyst may include, e.g., iron (III) nitrate (Fe(NO₃)₃), nickel (II) nitrate (Ni(NO₃)₂), or a combination thereof. In an implementation, as the catalyst, an average particle diameter (D50) of, e.g., less than or equal to about 150 nm, or less than or equal to about 120 nm, and greater than 0 nm, may be used. If the average particle diameter (D50) of the catalyst were to exceed the above range, the reaction rate of conversion from a portion of the amorphous carbon to the graphitized carbon could be reduced or it could be difficult for the reaction itself to occur.

The catalyst is not consumed or changed in the process of conversion from a portion of the amorphous carbon to the graphitized carbon, and it may remain after the reaction. As a result, the negative active material composite of the embodiment may include the catalyst immediately after preparation. In an implementation, the catalyst may be removed from the negative active material composite of the embodiment and then used.

Composite

In an implementation, negative active material composite may include the silicon nanoparticles in an amount of, e.g., about 80 to 250 parts by weight, 90 to 230 parts by weight, or about 100 to 200 parts by weight, per 1 part by weight of the graphitized carbon. Within the above ranges, an effect of improving the capacity of the rechargeable lithium battery by the silicon nanoparticles and an effect of preventing a sharp decline in an initial cycle-life of the rechargeable lithium battery by the graphitized carbon may be harmonized.

In an implementation, the negative active material composite may include the amorphous carbon in an amount of, e.g., about 25 to 150 parts by weight, about 27 to 140 parts by weight, or about 30 to 135 parts by weight, per 1 part by weight of the graphitized carbon. Within the above ranges, an effect of preventing a sharp decline in an initial cycle-life of the rechargeable lithium battery by the graphitized carbon and an effect of securing the long-term cycle-life of the rechargeable lithium battery by the amorphous carbon may be harmonized.

In an implementation, based on the total weight of the negative active material composite, the graphitized carbon may be included in an amount of, e.g., about 0.1 wt % to about 1 wt %, about 0.2 wt % to about 0.9 wt %, about 0.3 wt % to about 0.7 wt %, or about 0.3 wt % to about 0.55 wt %. In an implementation, the silicon nanoparticles may be included in an amount of, e.g., about 35 wt % to about 85 wt %, about 40 wt % to about 85 wt %, about 50 wt % to about 85 wt %, or about 59 wt % to about 80 wt %. In an implementation, the amorphous carbon may be included in a balance amount. Within the above ranges, an effect of improving the capacity of the rechargeable lithium battery by the silicon nanoparticles, an effect of preventing a sharp decline in the initial cycle-life of the rechargeable lithium battery by the graphitized carbon, and an effect of securing the long-term cycle-life of the rechargeable lithium battery by the amorphous carbon may be harmonized. For reference, each content of each component of the negative active material composite may be quantified through ICP, TGA, and XRF analyses.

In an implementation, average particle diameter (D50) of the negative active material composite may be, e.g., about 2 μm to about 15 and the maximum particle diameter (Dₘₐₓ) may be, e.g., about 5 μm to about 40 In an implementation, the average particle diameter (D50) of the composite may be, e.g., greater than or equal to about 2 greater than or equal to about 3 greater than or equal to about 4 or greater than or equal to about 5 and less than or equal to about 15 less than or equal to about 14 less than or equal to about 13 less than or equal to about 12 or less than or equal to about 11 In an implementation, the maximum particle diameter (Dₘₐₓ) of the composite may be, e.g., greater than or equal to about 5, greater than or equal to about 7 μm, greater than or equal to about 10 μm, greater than or equal to about 11 μm, greater than or equal to about 12 μm, or greater than or equal to about 13 μm, and less than or equal to about 40 μm, less than or equal to about 38 μm, less than or equal to about 36 μm, less than or equal to about 34 μm, or less than or equal to about 32 μm. Within these ranges, an excessive increase in the specific surface area of the negative active material composite may be suppressed to help reduce side reactions with the electrolyte, and to help improve rate capability while suppressing a resistance of the rechargeable lithium battery.

The negative active material composite may include a matrix including the amorphous carbon; the silicon nanoparticles inside the matrix; and the graphitized carbon distributed on the surface of the matrix, inside of the matrix, or both on the surface of the matrix and inside of the matrix.

In an implementation, inside the matrix, a plurality of the silicon nanoparticles may be aggregated to form secondary particles. When such a structure is formed, the silicon nanoparticles may not only realize an effect of improving capacity of the rechargeable lithium battery, but also the matrix including the amorphous carbon surrounds the silicon nanoparticles and maintains the dense structure and thereby, may reduce a side reaction with an electrolyte solution and further improve long-term cycle-life of the rechargeable lithium battery.

Simultaneously, the graphitized carbon may be all distributed on the surface of the matrix, inside the matrix, or both thereof to help improve adhesion between the silicon nanoparticles and the amorphous carbon, between the negative active material composite and a negative current collector, and the like and thus prevent a sharp decline in an initial cycle-life of the rechargeable lithium battery.

The matrix may have a thickness of, e.g., about 1 nm to about 900 nm, or about 5 nm to about 800 nm, on the outer surface of the silicon nanoparticles. Within these ranges, an internal pore size and a volume of the composite may be controlled, a degree of penetration of the electrolyte into the interior of the negative active material composite may be controlled, and a side reaction between the electrolyte and the negative active material composite may be minimized to help improve cycle-life characteristics of the rechargeable lithium battery.

(Method of Preparing Negative Active Material)

In an implementation, a method of preparing a negative active material composite for a rechargeable lithium battery may include, e.g., spray-drying a slurry including a solvent, a catalyst, and silicon nanoparticles; and heat-treating a mixture including the obtained product of the spray-drying and an amorphous carbon precursor.

Through the above series of processes, the negative active material composite of the aforementioned embodiment may be obtained. Hereinafter, descriptions overlapping with the above may be omitted and each process will be described.

Spray-Drying

First, spray-drying the slurry including the solvent, catalyst, and silicon nanoparticles may be performed.

In an implementation, the spray-drying of the slurry including the solvent, catalyst, and silicon nanoparticles may include dispersing the silicon nanoparticles in the solvent to prepare a dispersion; milling the dispersion; adding the catalyst to the milled dispersion to prepare a slurry for spray-drying; and spray-drying the slurry for spray-drying.

A dispersant may be added during the preparation of the dispersion. In an implementation, the silicon nanoparticles and the dispersant may be used in a weight ratio of, e.g., about 99:1 to about 80:20, about 97:3 to about 85:15, or about 95:5 to about 87:13. The dispersant may be a material that may function both as a dispersant and as a precursor of the graphitized carbon. In an implementation, stearic acid may be a material carbonized by a heat treatment as well as increasing dispersibility of the silicon nanoparticles in the solvent.

After preparing the dispersion, a catalyst may be added, and the catalyst may include, e.g., iron (III) nitrate (Fe(NO₃)₃), nickel (II) nitrate (Ni(NO₃)₂), or a combination of thereof. An amount of the catalyst may be determined to include a metal in an amount of, e.g., about 0.1 parts by weight to about 5 parts by weight, about 0.3 parts by weight to about 4 parts by weight, about 0.5 parts by weight to about 3 parts by weight, or about 0.7 parts by weight to about 2 parts by weight, based on 100 parts by weight of the silicon nanoparticles.

The solvent may be a suitable solvent capable of dispersing both the catalyst and the silicon nanoparticles, but may include isopropyl alcohol (IPA), ethanol (EtOH), or the like. In an implementation, an amount of the solvent may be determined to include an amount of solids (i.e., a total amount of the catalyst and the silicon nanoparticles) in a range of, e.g., about 1 wt % to about 30 wt %, about 3 wt % to about 25 wt %, about 5 wt % to about 20 wt %, or about 7 wt % to about 15 wt % based on 100 wt % of the slurry for spray-drying.

The spray-drying may be performed at about 120° C. to about 170° C. using a spray dryer. The obtained product of the spray-drying may be secondary particles in which a plurality of silicon nanoparticles are aggregated.

Mixing and Heat-Treating of Amorphous Carbon Precursor with the Obtained Product of the Spray-Drying

In an implementation, the obtained product of the spray-drying may be mixed with an amorphous carbon precursor and then heat-treated.

The amorphous carbon precursor may include, e.g., pitches such as coal-based pitch and petroleum-based pitch; resins such as phenol resins and furan resins; or hydrocarbons having 1 to 10 carbon atoms. In an implementation, the pitch may be used from the viewpoint of economy or the like.

The obtained product of the spray-drying and the amorphous carbon precursor may be mixed in a weight ratio of, e.g., about 95:5 to about 40:60, about 90:10 to about 50:50, about 85:15 to about 55:45, or about 80:20 to about 60:40.

The mixture of the obtained product of the spray-drying and the amorphous carbon precursor may be heat-treated at, e.g., about 600° C. to about 1,200° C., about 650° C. to about 1,100° C., or about 700° C. to about 1,000° C. During this process, the amorphous carbon precursor may surround secondary particles in which a plurality of the silicon nanoparticles are aggregated to form a matrix, wherein the amorphous carbon precursor is converted into amorphous carbon, and a portion of the amorphous carbon may be converted into graphitized carbon.

The heat treatment may be performed under a nitrogen (N₂) atmosphere in a furnace.

(Negative Electrode)

In an implementation, a negative electrode for a rechargeable lithium battery may include a current collector and a negative active material layer on the current collector. In an implementation, the negative active material layer may include the negative active material composite according to the aforementioned embodiment.

The negative electrode of the above embodiment may include the negative active material composite of the aforementioned embodiment, and capacity, efficiency, and cycle-life of the rechargeable lithium battery may be simultaneously secured. Hereinafter, descriptions overlapping with the above may be omitted, and configurations other than the negative active material composite will be described.

Current Collector

The current collector may include, e.g., a copper foil, a nickel foil, a stainless steel foil, a titanium foil, a nickel foam, a copper foam, a polymer substrate coated with a conductive metal, or a combination thereof.

Negative Active Material Layer

The negative active material layer may essentially include the negative active material composite of the aforementioned embodiment. In an implementation, the negative active material layer may further include a negative active material different from the composite of the aforementioned embodiment. In this case, the negative active material composite of the aforementioned embodiment and the negative active material different therefrom may be in a weight ratio of, e.g., about 99:1 to about 80:20, or about 95:5 to about 85:15.

The negative active material different from the composite of the aforementioned embodiment may include a material that reversibly intercalates/deintercalates lithium ions, lithium metal, lithium metal alloy, material being capable of doping and dedoping lithium, or a transition metal oxide.

The material that reversibly intercalates/deintercalates lithium ions may include, e.g., crystalline carbon, amorphous carbon, or a combination thereof, as a carbon negative active material. The crystalline carbon may be non-shaped, or sheet, flake, spherical, or fiber shaped natural graphite or artificial graphite. The amorphous carbon may be a soft carbon, a hard carbon, a mesophase pitch carbonization product, calcined coke, or the like.

The lithium metal alloy may include an alloy of lithium and, e.g., Na, K, Rb, Cs, Fr, Be, Mg, Ca, Sr, Si, Sb, Pb, In, Zn, Ba, Ra, Ge, Al, or Sn.

The material capable of doping/dedoping lithium may be a Si negative active material or a Sn negative active material. The Si negative active material may include silicon, a silicon-carbon composite, SiOₓ (0<x<2), a Si-Q alloy (wherein Q is an alkali metal, an alkaline-earth metal, a Group 13 element, a Group 14 element, a Group 15 element, a Group 16 element, a transition metal, a rare earth element, or a combination thereof, but not Si) and the Sn negative active material may include Sn, SnO₂, Sn—R alloy (wherein R is an alkali metal, an alkaline-earth metal, a Group 13 element, a Group 14 element, a Group 15 element, a Group 16 element, a transition metal, a rare earth element, or a combination thereof, but not Sn). At least one of these materials may be mixed with SiO₂. The elements Q and R may include Mg, Ca, Sr, Ba, Ra, Sc, Y, Ti, Zr, Hf, Rf, V, Nb, Ta, db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, or a combination thereof.

The silicon-carbon composite may be, e.g., a silicon-carbon composite including a core including crystalline carbon and silicon particles and an amorphous carbon coating layer disposed on the surface of the core. The crystalline carbon may be artificial graphite, natural graphite, or a combination thereof. The amorphous carbon precursor may be a coal-based pitch, mesophase pitch, petroleum-based pitch, coal-based oil, petroleum-based heavy oil, or a polymer resin such as a phenol resin, a furan resin, or a polyimide resin. In an implementation, the content of silicon may be, e.g., about 10 wt % to about 50 wt % based on the total weight of the silicon-carbon composite. In an implementation, the content of the crystalline carbon may be, e.g., about 10 wt % to about 70 wt % based on the total weight of the silicon-carbon composite, and the content of the amorphous carbon may be, e.g., about 20 wt % to about 40 wt %, based on the total weight of the silicon-carbon composite. In an implementation, a thickness of the amorphous carbon coating layer may be, e.g., about 5 nm to about 100 nm. An average particle diameter (D50) of the silicon particles may be, e.g., about 10 nm to about 20 μm. In an implementation, the average particle diameter (D50) of the silicon particles may be, e.g., about 10 nm to about 200 nm. The silicon particles may exist in an oxidized form, and in this case, an atomic content ratio of Si:O in the silicon particles indicating a degree of oxidation may be a weight ratio of, e.g., about 99:1 to about 33:66. The silicon particles may be SiOₓ particles, and in this case, the range of x in SiOₓ may be greater than about 0 and less than about 2. As used herein, when a definition is not otherwise provided, an average particle diameter (D50) indicates a particle where an accumulated volume is about 50 volume % in a particle distribution.

The Si negative active material or Sn negative active material may be mixed with the carbon negative active material. When the Si negative active material or Sn negative active material and the carbon negative active material are mixed and used, the mixing ratio may be a weight ratio of, e.g., about 1:99 to about 90:10.

In the negative active material layer, the negative active material may be included in an amount of, e.g., about 60 wt % to about 90 wt %, based on the total weight of the negative active material layer.

In an implementation, the negative active material layer may further include a binder. In an implementation, the negative active material layer may further include a conductive material. The content of the binder in the negative active material layer may be, e.g., about 1 wt % to about 30 wt %, based on the total weight of the negative active material layer. In an implementation, when the conductive material is further included, the negative active material layer may include, e.g., about 60 wt % to about 90 wt % of the negative active material, about 1 wt % to about 30 wt % of the binder, and about 1 wt % to about 30 wt % of the conductive material.

The binder may serve to adhere the negative active material particles to each other well, and also to adhere the negative active material to the current collector. The binder may be, e.g., a water-insoluble binder, a water-soluble binder, or a combination thereof.

Examples of the water-insoluble binder may include polyvinyl chloride, carboxylated polyvinyl chloride, polyvinyl fluoride, an ethylene oxide-containing polymer, an ethylene propylene copolymer, polystyrene, polyvinylpyrrolidone, polyurethane, polytetrafluoro ethylene, polyvinylidene fluoride, polyethylene, polypropylene, polyamideimide, polyimide, or a combination thereof.

The water-soluble binder may include a rubber binder or a polymer resin binder. The rubber binder may include a styrene-butadiene rubber, an acrylated styrene-butadiene rubber, an acrylonitrile-butadiene rubber, an acrylic rubber, a butyl rubber, a fluororubber, or a combination thereof. The polymer resin binder may include polyethylene oxide, polyvinylpyrrolidone, polyepichlorohydrin, polyphosphazene, polyacrylonitrile, an ethylene propylene diene copolymer, polyvinylpyridine, chlorosulfonated polyethylene, latex, a polyester resin, an acrylic resin, a phenol resin, an epoxy resin, polyvinyl alcohol, or a combination thereof.

When a water-soluble binder is used as the negative electrode binder, a cellulose compound capable of imparting viscosity may be further included. As the cellulose compound, one or more of carboxymethyl cellulose, hydroxypropylmethyl cellulose, methyl cellulose, or alkali metal salts thereof may be mixed and used. As the alkali metal, Na, K, or Li may be used. The amount of such a thickener used may be, e.g., about 0.1 parts by weight to about 3 parts by weight, based on 100 parts by weight of the negative active material.

The conductive material may be included to provide electrode conductivity. A suitable electrically conductive material that does not cause a chemical change may be used. Examples of the conductive material may include a carbon material such as natural graphite, artificial graphite, carbon black, acetylene black, ketjen black, a carbon fiber, carbon nanotube, or the like; a metal material of a metal powder or a metal fiber including copper, nickel, aluminum silver, or the like; a conductive polymer such as a polyphenylene derivative; or a mixture thereof.

The negative current collector may include a copper foil, a nickel foil, a stainless steel foil, a titanium foil, a nickel foam, a copper foam, a polymer substrate coated with a conductive metal, or a combination thereof.

(Rechargeable Lithium Battery)

In another embodiment, a rechargeable lithium battery may include a positive electrode; a negative electrode; and an electrolyte, wherein the negative electrode is the negative electrode of the aforementioned embodiment.

The rechargeable lithium battery of the embodiment may include the negative electrode of the aforementioned embodiment, and the capacity, efficiency, and cycle-life of the rechargeable lithium battery may be simultaneously secured. Hereinafter, descriptions overlapping with those described above may be omitted, and configurations other than the negative electrode will be described.

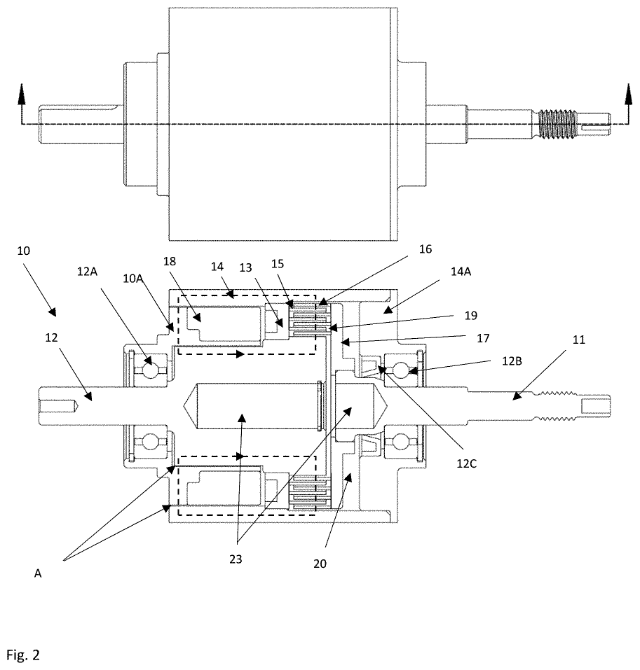

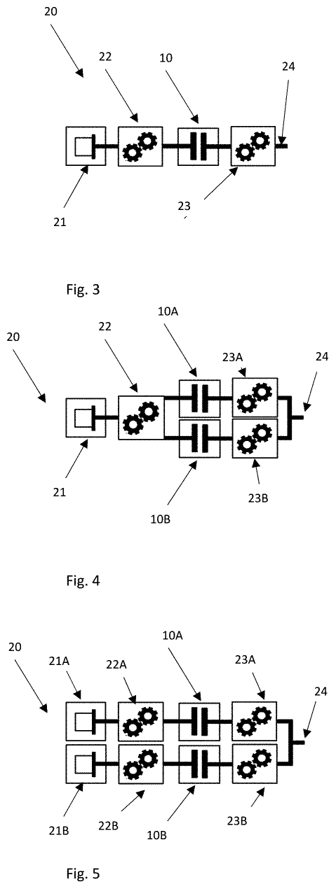

FIG. 2 is a perspective view of a pouch-type rechargeable battery according to an embodiment, FIG. 3 is a vertical cross-sectional view taken along the line I-I in FIG. 2 in the arrow direction, and FIG. 4 is a horizontal cross-sectional view taken along the line II-II in FIG. 2 in the arrow direction. In an implementation, as illustrated in the drawings, the rechargeable lithium battery according to an embodiment may include a stack-type electrode assembly placed in a pouch-type case. In an implementation, the electrode assembly such as a stack type, a winding type (jelly roll type), a stack-and-fold type, and a Z-fold type may be applied to a battery in the case of a type in a cylindrical, prismatic, coin type, or the like.

Referring to FIGS. 2 to 4, the pouch-type rechargeable battery 100 according to an embodiment may include an electrode assembly 10 in which a separator 13 is between the positive electrode 11 and the negative electrode 12, an electrode assembly 10 accommodated in an exterior material 25, a positive terminal 21 electrically connected to the positive electrode 11, and a negative terminal 22 electrically connected to the negative electrode 12.

In an implementation, the electrode assembly 10 may have a structure in which a plurality of positive electrodes 11 and negative electrodes 12 having a rectangular sheet shape are alternately stacked with a separator 13 therebetween. In an implementation, the electrode assembly may have a structure in which a separator is between a strip-shaped positive electrode and a negative electrode and then wound.

In the electrode assembly 10, a positive electrode uncoated region 11a and a negative electrode uncoated region 12a may be at one end of the electrode assembly 10, the positive electrode terminal 21 may be attached to the positive uncoated region 11a by welding, and the negative electrode terminal 22 may be attached to the negative electrode uncoated region 12a by welding.

The positive electrode 11, the negative electrode 12, and the separator 13 may each have a rectangular sheet shape. In an implementation, the electrode assembly 10 may be accommodated in the exterior material 25 and sealed by the sealing portion 30 along the edge of the exterior material 25.

The exterior material 25 may include an upper exterior material 25a and a lower exterior material 25b. The upper exterior material 25a and the lower exterior material 25b may each have a multi-layered structure. The structures of the upper exterior material 25a and the lower exterior material 25b may be the same as each other and thus hereinafter, an example will be described based on the upper exterior material 25a. The upper exterior material 25a may have a configuration in which an external resin layer, a metal layer, and an internal resin layer are sequentially stacked.

In an implementation, as shown in FIG. 3, the sealing portion 30 may be on the edge of the exterior material 25. In an implementation, each insulating member 40 may be attached to each of the positive terminal 21 and the negative terminal 22.

Positive Electrode

The positive electrode may include a current collector and a positive active material layer on the current collector.

The positive active material layer may include a positive active material, and may further include, e.g., a binder or a conductive material.

The positive active material may include lithiated intercalation compounds that reversibly intercalate and deintercalate lithium ions. Examples of the positive active material may include a compound represented by any one of the following chemical formulas.

LiₐA_{1-b}X_{b}D₂ (0.90≤a≤1.8, 0≤b≤0.5);

LiₐA_{1-b}X_{b}O_{2-c}D_{c} (0.90≤a≤1.8, 0≤b≤0.5, 0≤c≤0.05);

LiₐE_{1-b}X_{b}O_{2-c}D_{c} (0.90≤a≤1.8, 0≤b≤0.5, 0≤c≤0.05);

LiₐE_{2-b}X_{b}O_{4-c}D_{c} (0.90≤a≤1.8, 0≤b≤0.5, 0≤c≤0.05);

LiₐNi_{1-b-c}Co_{b}X_{c}D_{α} (0.90≤a≤1.8, 0≤b≤0.5, 0≤c≤0.5, 0<α≤2);

LiₐNi_{1-b-c}Co_{b}X_{c}O_{2-α}T_{α} (0.90≤a≤1.8, 0≤b≤0.5, 0≤c≤0.05, 0<α<2);

LiₐNi_{1-b-c}Co_{b}X_{c}O_{2-α}T₂ (0.90≤a≤1.8, 0≤b≤0.5, 0≤c≤0.05, 0<α<2);

LiₐNi_{1-b-c}Mn_{b}X_{c}D_{α} (0.90≤a≤1.8, 0≤b≤0.5, 0≤c≤0.05, 0<α≤2);

LiₐNi_{1-b-c}Mn_{b}X_{c}O_{2-α}T_{α} (0.90≤a≤1.8, 0≤b≤0.5, 0≤c≤0.05, 0<α<2);

LiₐNi_{1-b-c}Mn_{b}X_{c}O_{2-α}T₂ (0.90≤a≤1.8, 0≤b≤0.5, 0≤c≤0.05, 0<α<2);

LiₐNi_{b}E_{c}G_{d}O₂ (0.90≤a≤1.8, 0≤b≤0.9, 0≤c≤0.5, 0.001≤d≤0.1);

LiₐNi_{b}Co_{c}Mn_{d}GₑO₂ (0.90≤a≤1.8, 0≤b≤0.9, 0≤c≤0.5, 0≤d≤0.5, 0.001≤e≤0.1);

LiₐNiG_{b}O₂ (0.90≤a≤1.8, 0.001≤b≤0.1);

LiₐCoG_{b}O₂ (0.90≤a≤1.8, 0.001≤b≤0.1);

LiₐMn_{1-b}G_{b}O₂ (0.90≤a≤1.8, 0.001≤b≤0.1);

LiₐMn₂G_{b}O₄ (0.90≤a≤1.8, 0.001≤b≤0.1);

LiₐMn_{1-g}G_{g}PO₄ (0.90≤a≤1.8, 0≤g≤0.5);

QO₂; QS₂; LiQS₂;

V₂O₅; LiV₂O₅;

LiZO₂;

LiNiVO₄;

Li_{(3-f)}J₂(PO₄)₃(0≤f≤2);

Li_{(3-f)}Fe₂(PO₄)₃ (0≤f≤2); and

LiₐFePO₄ (0.90≤a≤1.8).

In chemical formulas, A may be Ni, Co, Mn, or a combination thereof; X may be Al, Ni, Co, Mn, Cr, Fe, Mg, Sr, V, a rare earth element, or a combination thereof; D may be O, F, S, P, or a combination thereof; E may be Co, Mn, or a combination thereof; T may be F, S, P, or a combination thereof; G may be Al, Cr, Mn, Fe, Mg, La, Ce, Sr, V, or a combination thereof; Q may be Ti, Mo, Mn, or a combination thereof; Z may be Cr, V, Fe, Sc, Y, or a combination thereof; and J may be V, Cr, Mn, Co, Ni, Cu, or a combination thereof.

The compounds may have a coating layer on the surface, or may be mixed with another compound having a coating layer. The coating layer may include a coating element compound, e.g., an oxide of a coating element, a hydroxide of a coating element, an oxyhydroxide of a coating element, an oxycarbonate of a coating element, or a hydroxy carbonate of a coating element. The compound for the coating layer may be amorphous or crystalline. The coating element included in the coating layer may include, e.g., Mg, Al, Co, K, Na, Ca, Si, Ti, V, Sn, Ge, Ga, B, As, Zr, or a combination thereof. In the coating layer forming process, a method that does not adversely affect the physical properties of the positive active material, e.g., spray coating, dipping, or the like, may be used.

The positive active material may include, e.g., a lithium nickel composite oxide represented by Chemical Formula 11.

Liₐ₁₁Niₓ₁₁M¹¹_{y11}M¹²_{1-x11-y12}O₂ [Chemical Formula 11]

In Chemical Formula 11, 0.9≤a11≤1.8, 0.3≤x11≤1, 0≤y11≤0.7, and M¹¹ and M¹² may each independently be, e.g., Al, B, Ce, Co, Cr, F, Mg, Mn, Mo, Nb, P, S, Si, Sr, Ti, V, W, Zr, or a combination thereof.

In Chemical Formula 11, 0.4≤x11≤1 and 0≤y11≤0.6, 0.5≤x11≤1 and 0≤y11≤0.5, 0.6≤x11≤1 and 0≤y11≤0.4, or 0.7≤x11≤1 and 0≤y11≤0.3, 0.8≤x11≤1 and 0≤y11≤0.2, or 0.9≤x11≤1 and 0≤y11≤0.1.

In an implementation, the positive active material may include a lithium nickel cobalt composite oxide represented by Chemical Formula 12.

Liₐ₁₂Niₓ₁₂Co_{y12}M¹³_{1-x12-y12}O₂

In Chemical Formula 12, 0.9≤a12≤1.8, 0.3≤x12≤1, 0≤y12≤0.7, and M¹³ may be, e.g., Al, B, Ce, Cr, F, Mg, Mn, Mo, Nb, P, S, Si, Sr, Ti, V, W, Zr, or a combination thereof.

In Chemical Formula 12, 0.3≤x12≤0.99 and 0.01≤y12≤0.7, 0.4≤x12≤0.99 and 0.01≤y12≤0.6, 0.5≤x12≤0.99 and 0.01≤y12≤0.5, 0.6≤x12≤0.99 and 0.01≤y12≤0.4, 0.7≤x12≤0.99 and 0.01≤y12≤0.3, 0.8≤x12≤0.99 and 0.01≤y12≤0.2, or 0.9≤x12≤0.99 and 0.01≤y12≤0.1.

In an implementation, the positive active material may include a lithium nickel cobalt composite oxide represented by Chemical Formula 13.

Liₐ₁₃Niₓ₁₃Co_{y13}M¹⁴_{z13}M¹⁵_{1-x13-y13-z13}O₂

In Chemical Formula 13, 0.9≤a13≤1.8, 0.3≤x13≤0.98, 0.01≤y13≤0.69, 0.01≤z13≤0.69, MIA may be, e.g., Al, Mn, or a combination thereof, and M¹⁵ may be, e.g., B, Ce, Cr, F, Mg, Mo, Nb, P, S, Si, Sr, Ti, V, W, Zr, or a combination thereof.

In Chemical Formula 13, 0.4≤x13≤0.98, 0.01≤y13≤0.59, and 0.01≤z13≤0.59, 0.5≤x13≤0.98, 0.01≤y13≤0.49, and 0.01≤z13≤0.49, or 0.6≤x13≤0.98, 0.01≤y13≤0.39, and 0.01≤z13≤0.39, or 0.7≤x≤13≤0.98, 0.01≤y13≤0.29, and 0.01≤z13≤0.29, 0.8≤x13≤0.98, 0.01≤y13≤0.19, and 0.01≤z13≤0.19, or 0.9≤x13≤0.98, 0.01≤y13≤0.09, and 0.01≤z13≤0.09.

The content of the cathode active material may be about 90 wt % to about 98 wt %, e.g., about 90 wt % to about 95 wt %, based on the total weight of the positive active material layer. Each content of the binder and the conductive material may be, e.g., about 1 wt % to about 5 wt %, based on the total weight of the positive active material layer.

The binder may help improve binding properties of positive active material particles with one another and with a current collector. Examples thereof may include polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like.

The conductive material may be included to provide electrode conductivity. A suitable electrically conductive material that does not cause a chemical change may be used. Examples of the conductive material may include a carbon material such as natural graphite, artificial graphite, carbon black, acetylene black, ketjen black, a carbon fiber, and the like; a metal material of a metal powder or a metal fiber including copper, nickel, aluminum, silver, and the like; a conductive polymer such as a polyphenylene derivative; or a mixture thereof.

In an implementation, an aluminum foil may be used as the positive current collector.

Separator

The separator separates a positive electrode and a negative electrode and provides a transporting passage for lithium ions and may be a suitable separator for a lithium ion battery. In an implementation, it may have low resistance to ion transport and excellent impregnation for an electrolyte. In an implementation, separator may include a glass fiber, polyester, Teflon, polyethylene, polypropylene, polytetrafluoroethylene, or a combination thereof. It may have a form of a non-woven fabric or a woven fabric. In an implementation, in a lithium ion battery, a polyolefin polymer separator such as polyethylene and polypropylene may be used. In order to ensure the heat resistance or mechanical strength, a coated separator including a ceramic component or a polymer material may be used. In an implementation, it may have a mono-layered or multi-layered structure.

Electrolyte

The electrolyte may include, e.g., a non-aqueous organic solvent and a lithium salt.

The non-aqueous organic solvent serves as a medium for transmitting ions taking part in the electrochemical reaction of a battery. The non-aqueous organic solvent may include, e.g., a carbonate, ester, ether, ketone, alcohol, or aprotic solvent. Examples of the carbonate solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like. Examples of the ester solvent may include methyl acetate, ethyl acetate, n-propyl acetate, dimethyl acetate, methyl propionate, ethyl propionate, γ-butyrolactone, decanolide, valerolactone, mevalonolactone, caprolactone, and the like. The ether solvent may include dibutyl ether, tetraglyme, diglyme, dimethoxyethane, 2-methyltetrahydrofuran, tetrahydrofuran, and the like and the ketone-based solvent may be cyclohexanone, or the like. The alcohol solvent may include ethyl alcohol, isopropyl alcohol, or the like, The aprotic solvent may include nitriles such as R—CN (where R is a C2 to C20 linear, branched, or cyclic hydrocarbon group and may include a double bond, an aromatic ring, or an ether bond), amides such as dimethylformamide, dioxolanes such as 1,3-dioxolane, sulfolanes, or the like.

The non-aqueous organic solvent may be used alone or in a mixture. When the organic solvent is used in a mixture, the mixture ratio may be controlled in accordance with a desirable battery performance.

In an implementation, in the case of the carbonate solvent, a mixture of a cyclic carbonate and a chain carbonate may be used. In this case, when the cyclic carbonate and the chain carbonate are mixed in a volume ratio of about 1:1 to about 1:9, the electrolyte may exhibit excellent performance.

The non-aqueous organic solvent may further include an aromatic hydrocarbon organic solvent in addition to the carbonate solvent. In this case, the carbonate solvent and the aromatic hydrocarbon organic solvent may be mixed in a volume ratio of about 1:1 to about 30:1.

As the aromatic hydrocarbon solvent, an aromatic hydrocarbon compound represented by Chemical Formula I may be used.

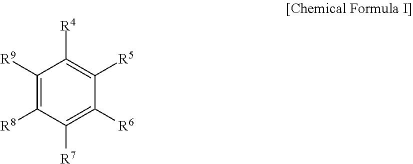

In Chemical Formula I, R⁴ to R⁹ are the same or different and may be selected from hydrogen, a halogen, a C1 to C10 alkyl group, a haloalkyl group, and a combination thereof.

Examples of the aromatic hydrocarbon solvent may include benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, and a combination thereof.

The electrolyte may further include vinylene carbonate or an ethylene carbonate compound of Chemical Formula II in order to help improve cycle-life of a battery.

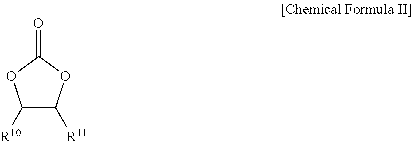

In Chemical Formula II, R¹⁰ and R¹¹ are the same or different, and may be selected from hydrogen, a halogen, a cyano group, a nitro group, and fluorinated C1 to C5 alkyl group, provided that at least one of R¹⁰ and R¹¹ is a halogen, a cyano group, a nitro group, or fluorinated C1 to C5 alkyl group, but both of R¹⁰ and R¹¹ are not hydrogen.

Examples of the ethylene carbonate compound may include difluoro ethylenecarbonate, chloroethylene carbonate, dichloroethylene carbonate, bromoethylene carbonate, dibromoethylene carbonate, nitroethylene carbonate, cyanoethylene carbonate, and fluoroethylene carbonate. The amount of the additive for improving cycle-life may be used within an appropriate range.

The lithium salt dissolved in the non-organic solvent supplies lithium ions in a battery, enables a basic operation of a rechargeable lithium battery, and improves transportation of the lithium ions between positive and negative electrodes.

Examples of the lithium salt may include LiPF₆, LiBF₄, LiSbF₆, LiAsF₆, LiN(SO₂C₂F₅)₂, Li(CF₃SO₂)₂N, LiN(SO₃C₂F₅)₂, Li(FSO₂)₂N (lithium bis(fluorosulfonyl)imide; LiFSI), LiC₄F₉SO₃, LiClO₄, LiAlO₂, LiAlCl₄, LiPO₂F₂, LiN(CₓF₂ₓ₊₁SO₂)(C_{y}F_{2y+1}SO₂) (wherein x and y are natural numbers, e.g., an integer ranging from 1 to 20), lithium difluoro(bisoxolato) phosphate, LiCl, LiI, LiB(C₂O₄)₂ (lithium bis(oxalato) borate; LiBOB), and lithium difluoro(oxalato)borate (LiDFOB).

The lithium salt may be used in a concentration ranging from about 0.1 M to about 2.0 M. When the lithium salt is included at the above concentration range, an electrolyte may have excellent performance and lithium ion mobility due to optimal electrolyte conductivity and viscosity.

Rechargeable lithium batteries may be classified as, e.g., lithium ion batteries, lithium ion polymer batteries, and lithium polymer batteries, according to the presence of a separator and the type of electrolyte used therein. The rechargeable lithium batteries may have a variety of shapes and sizes, and include cylindrical, prismatic, coin, or pouch-type batteries, and may be thin film batteries or may be rather bulky in size. Structures and manufacturing methods for lithium ion batteries pertaining to this disclosure are well known in the art.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

### Example 1

(1) Preparation of Negative Active Material Composite

As a solvent, a mixed solvent including IPA and EtOH in a volume ratio of 3:7 was prepared. Subsequently, 9 parts by weight of silicon nanoparticles (D50: 100 nm, aspect ratio: 10, XRD full width at half maximum@(111): 0.61°) and 1 part by weight of stearic acid were added to 90 parts by weight of the mixed solvent and then, milled with zirconium balls of 5 mm to 10 mm. Accordingly, a solution in which the silicon nanoparticles were uniformly dispersed in the mixed solvent was obtained.

Subsequently, iron (III) nitrate was added to the solution and dispersed therein, obtaining a slurry for spray-drying. Herein, the metal in the iron (III) nitrate was controlled to be 1 part by weight based on 100 parts by weight of the silicon nanoparticles in the solution, so that a final iron nitrate had a D5 particle diameter of 100 nm. In addition, a solid content (i.e., a total amount of the iron(III) nitrate and the silicon nanoparticles) was adjusted to be 10.1 wt % in the slurry for spray-drying.

The slurry for spray-drying was spray-dried at 150° C. at a spray rate of 60 g/min by using a spray drier.

60 parts by weight of the obtained product of the spray-drying was mixed with 40 parts by weight of petroleum-based pitch, which is a type of an amorphous carbon precursor, and then, heat-treated at 1,000° C. under an N₂ atmosphere, preparing a negative active material composite.

(2) Manufacture of Negative Electrode

A negative active material slurry was prepared by mixing 70 wt % of the negative active material composite, 15 wt % of a conductive material (Super-P), and 15 wt % of a binder (polyacrylic acid (PAA)) in water as a solvent. The negative active material slurry was coated on one surface of a copper foil with a width of 76.5 mm, a length of 48.0 mm, and a thickness of 10 μm and then, dried and pressed, manufacturing a negative electrode. Herein, the coating of the negative active material slurry adopted die coating.

(3) Manufacture of Positive Electrode

A positive active material slurry was prepared by mixing 95 wt % of LiCoO₂ as a positive active material, 3 wt % of polyvinylidene fluoride as a binder, and 2 wt % of ketjen black as a conductive material in an N-methylpyrrolidone solvent. The positive active material slurry was coated on one surface of an aluminum current collector with a width of 74.5 mm, a length of 45.0 mm, and a thickness of 12 μm to be 71 μm thick and then, dried and pressed, obtaining a 154 μm-thick positive active material layer. Herein, the coating of the positive active material slurry was performed by adopting die coating.

(4) Manufacture of Battery Cell

A polyethylene separator with a width of 76.5 mm, a length of 48.0 mm, and a thickness of 14 μm was inserted between the negative electrode and the positive electrode and assembled therewith. Herein, the coated surface of the negative electrode was in contact with the separator.

The electrode assembly was put into a pouch, and an electrolyte solution included 10% of FEC in a 1.10 M LiPF₆ solution of a mixed solvent of ethylene carbonate and diethyl carbonate in a volume ratio of 50:50, manufacturing a rechargeable lithium battery cell.

### Example 2

During the preparation of the negative active material composite, silicon nanoparticles (D50: 50 nm, aspect ratio: 10, XRD full width at half maximum 0.85°) were used instead of the silicon nanoparticles (D50: 100 nm, aspect ratio: 10, XRD full width at half maximum: 0.61°). Except for this, a negative active material composite, a negative electrode, and a rechargeable lithium battery according to Example 2 were manufactured in the same manner as in Example 1.

### Example 3

During the preparation of the negative active material composite, 70 parts by weight of the obtained product of the spray-drying was mixed with 30 parts by weight of the petroleum-based pitch. Except for this, a negative active material composite, a negative electrode, and a rechargeable lithium battery cell according to Example 3 were manufactured in the same manner as in Example 1.

### Example 4

During the preparation of the negative active material composite, 80 parts by weight of the obtained product of the spray-drying was mixed with 20 parts by weight of the petroleum-based pitch. Except for this, a negative active material composite, a negative electrode, and a rechargeable lithium battery cell according to Example 4 were manufactured in the same manner as in Example 1.

### Example 5

During the preparation of the negative active material composite, the iron (III) nitrate used in an amount of 0.5 wt % instead of 1 wt % of the amount of silicon was used to adjust a final iron (III) nitrate catalyst to have a D50 particle diameter of 80 nm. Except for this, a negative active material composite, a negative electrode, and a rechargeable lithium battery cell according to Example 5 were manufactured in the same manner as in Example 1.

### Example 6

During the preparation of the negative active material composite, the iron (III) nitrate used in an amount of 1.5 wt % instead of 1 wt % of the amount of silicon to adjust a final iron (III) nitrate catalyst to have a D50 particle diameter of 120 nm. Except for this, a negative active material composite, a negative electrode, and a rechargeable lithium battery cell according to Example 6 were manufactured in the same manner as in Example 1.

### Example 7

During the preparation of the negative active material composite, an iron (II) nitrate catalyst was used instead of the iron (III) nitrate catalyst and also, adjusted to have a final D50 a particle diameter of 100 nm. Except for this, a negative active material composite, a negative electrode, and a rechargeable lithium battery cell according to Example 7 were manufactured in the same manner as in Example 1.

### Comparative Example 1

Silicon nanoparticles (D50: 100 nm, aspect ratio: 10, XRD full width at half maximum: 0.61°) were mixed with artificial graphite (D50: 4 μm), preparing a negative active material according to Comparative Example 1. Except for this, a negative active material composite, a negative electrode, and a rechargeable lithium battery cell according to Comparative Example 1 were manufactured in the same manner as in Example 1.

### Comparative Example 2

(1) Preparation of Negative Active Material Composite

As a solvent, a mixed solvent including IPA and EtOH in a volume ratio of 3:7 was prepared. 9 parts by weight of silicon nanoparticles (D50: 100 nm, aspect ratio: 10, XRD full width at half maximum: 0.61°) was added to 80 parts by weight of the mixed solvent and then, milled by using zirconium balls of 5 to 10 mm. Accordingly, the silicon nanoparticles were uniformly dispersed in the mixed solvent, obtaining dispersion.

The dispersion was spray-dried at 150° C. at a spray rate of 60 g/min by using a spray drier.

60 parts by weight of the obtained product of the spray-drying was mixed with 40 parts by weight of petroleum-based pitch, which is a type of an amorphous carbon precursor, and then, heat-treated at 1,000° C. under an N₂ atmosphere, preparing a negative active material composite.

(2) Manufacture of Negative Electrode and Rechargeable Lithium Battery Cell

A negative active material composite, a negative electrode, and rechargeable lithium battery cell were manufactured in the same manner as in Example 1 except for using the negative active material composite of Comparative Example 2.

### Evaluation Example 1: Evaluation of Component Ratio of Negative Active Material Composite

Components of each negative active material composite according to Examples 1 to 7 and Comparative Examples 1 and 2 were quantified through ICP, TGA, and XRF analyses. The evaluation results are shown in Table 1.

For reference, in Table 1 below, Si@a-C means a composite of silicon nanoparticles (silicon, Si) and amorphous carbon (a-C), Si@a-C@graphite means a composite of silicon nanoparticles (Silicon, Si), amorphous carbon (amorphous carbon, a-C), and graphite (graphite), Si@a-C@g-C means a composite of silicon nanoparticles (Silicon, Si), amorphous carbon (a-C), and graphitic carbon (g-C).

TABLE 1
(wt %)

| | | | | Graphitized | |
|---|---|---|---|---|---|
| | Type of negative | Silicon | Amorphous | carbon or | |
| | active material | nanoparticles | carbon | graphite | Catalyst |
| Comparative | Si:graphite = | 50 | 0 | 50 | 0 |
| Example 1 | 5:5 (blending) | | | | |
| Comparative | Si@a-C | 60 | 40 | 0 | 0 |
| Example 2 | | | | | |
| Example 1 | Si@a-C@g-C | 59.5 | 39.4 | 0.55 | 0.55 |
| Example 2 | Si@a-C@g-C | 59.5 | 39.4 | 0.55 | 0.55 |
| Example 3 | Si@a-C@g-C | 69.4 | 29.4 | 0.55 | 0.65 |
| Example 4 | Si@a-C@g-C | 79.3 | 19.4 | 0.55 | 0.75 |
| Example 5 | Si@a-C@g-C | 59.7 | 39.6 | 0.4 | 0.3 |
| Example 6 | Si@a-C@g-C | 59.5 | 39.2 | 0.3 | 1 |
| Example 7 | Si@a-C@g-C | 59.5 | 39.4 | 0.55 | 0.55 |

### Evaluation Example 2: Evaluation of Physical Properties of Negative Active Material Composite

The negative active material composites according to Examples 1 to 7 and Comparative Examples 1 and 2 were evaluated in the following method, and the evaluation results are shown in Table 2.

(1) A_{D}/A_{G}: The negative active material composite was analyzed through Raman shift using a photon energy difference. A Raman spectrum thereof was measured by using a 785 nm wavelength laser. The measurement result was used to measure an integral area at a disordered peak (1,350 cm⁻¹) of the graphitized carbon and an integral area at an alignment peak (1,590 cm⁻¹) of the graphitized carbon to calculate A_{D}/A_{G}.

(2) D50: An average particle diameter (D50) of the negative active material composite was measured by using PSA (particle size analysis, Beckman Coulter, Inc.).

TABLE 2

| | Type of negative | | |
|---|---|---|---|
| | active material | A_{D}/A_{G} | D50 |
| Comparative Example 1 | Si:graphite = 5:5 (blending) | 0.04 | 13 μm |
| Comparative Example 2 | Si@a-C | 3.53 | 10 μm |
| Example 1 | Si@a-C@g-C | 3.18 | 10 μm |
| Example 2 | Si@a-C@g-C | 3.23 | 10 μm |
| Example 3 | Si@a-C@g-C | 3.25 | 10 μm |
| Example 4 | Si@a-C@g-C | 3.18 | 10 μm |
| Example 5 | Si@a-C@g-C | 3.43 | 10 μm |
| Example 6 | Si@a-C@g-C | 3.48 | 10 μm |
| Example 7 | Si@a-C@g-C | 3.15 | 10 μm |

In Table 2, when analyzing the Raman shift using a photon energy difference, the negative active material composite exhibited that as an amount of the graphitized carbon increased by the catalyst, an area of the carbonization peak in Raman increased.

### Evaluation Example 3: Evaluation of Electrochemical Characteristics of Rechargeable Lithium Battery Cells

Each rechargeable lithium battery cell according to Examples 1 to 7 and Comparative Examples 1 and 2 was evaluated with respect to electrochemical characteristics in the following method.

(1) Initial Efficiency: Each rechargeable lithium battery cell according to Examples 1 to 7 and Comparative Examples 1 and 2 was once charged and discharged at 0.1 C and then, evaluated with respect to initial charge and discharge efficiency, and the results are shown in Table 3.

(2) Cycle-life Characteristics: Each rechargeable lithium battery cell according to Examples 1 to 7 and Comparative Examples 1 and 2 was 300 times charged and discharged at 0.5 C at 25° C. A ratio of discharge capacity at the 300th cycle to discharge capacity at the 1^{st} cycle was calculated, and the results are shown in Table 3.

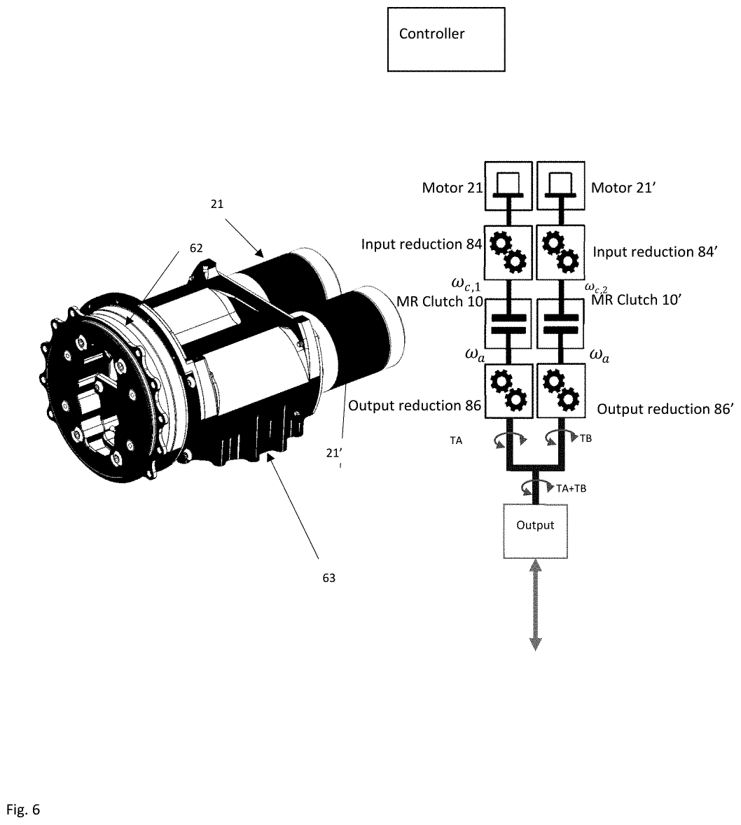

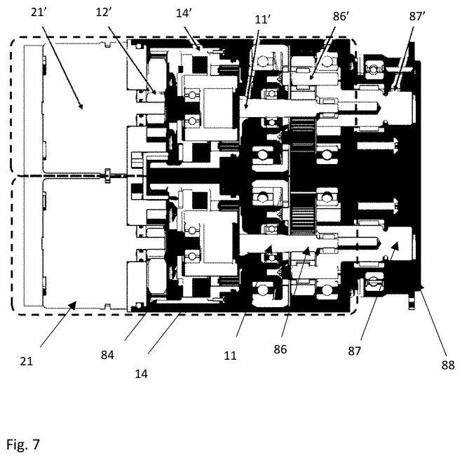

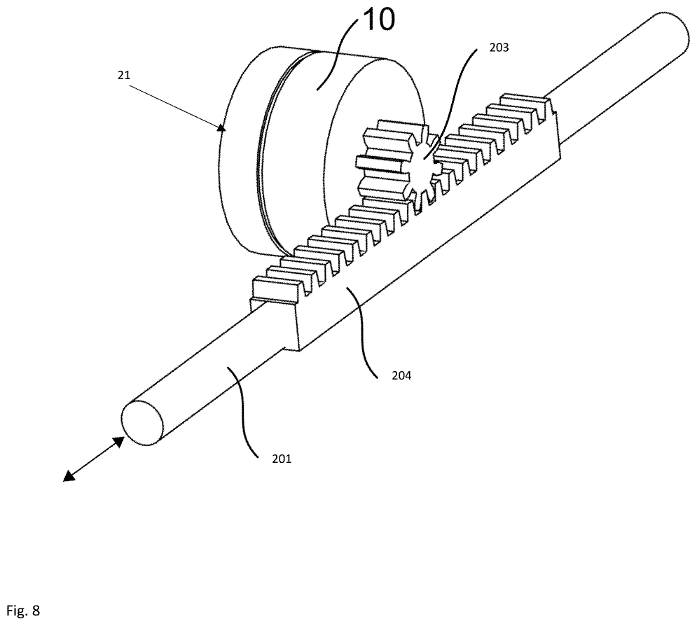

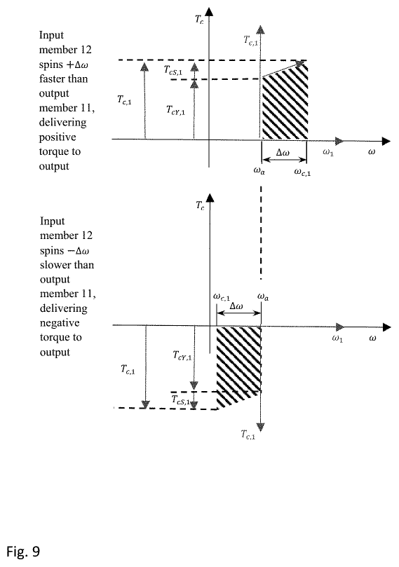

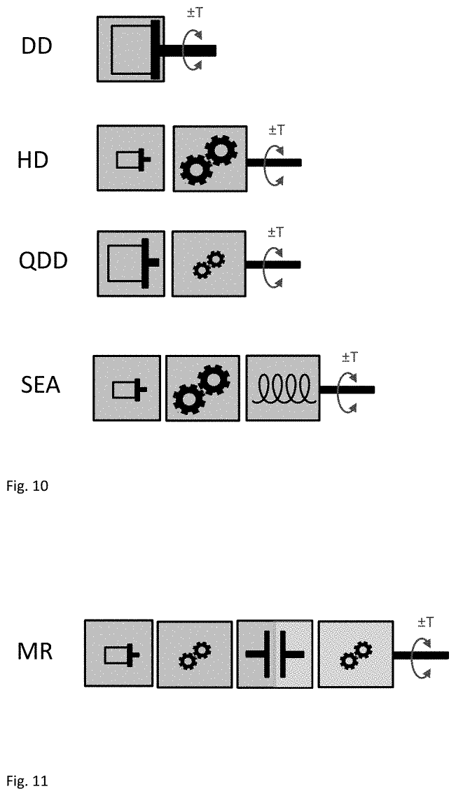

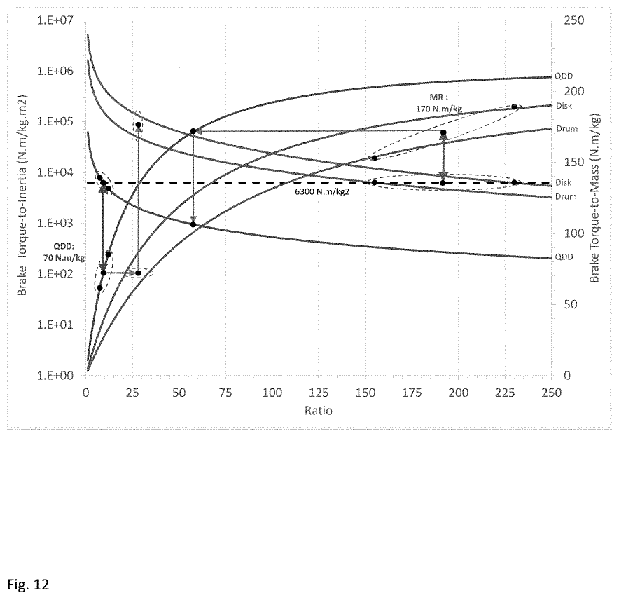

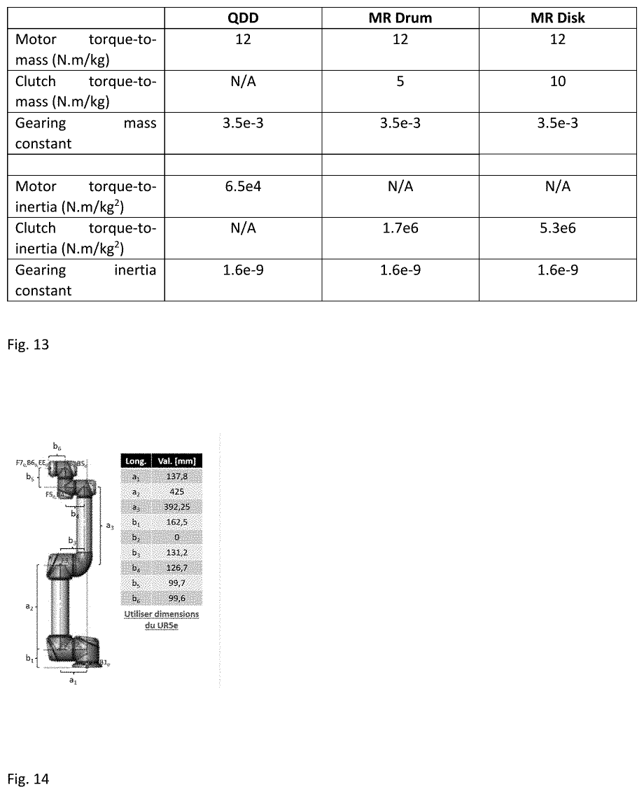

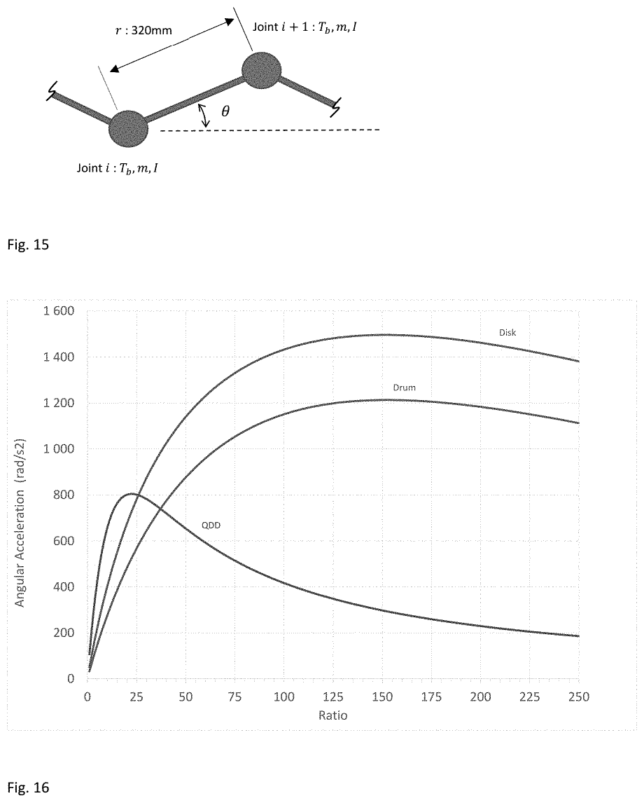

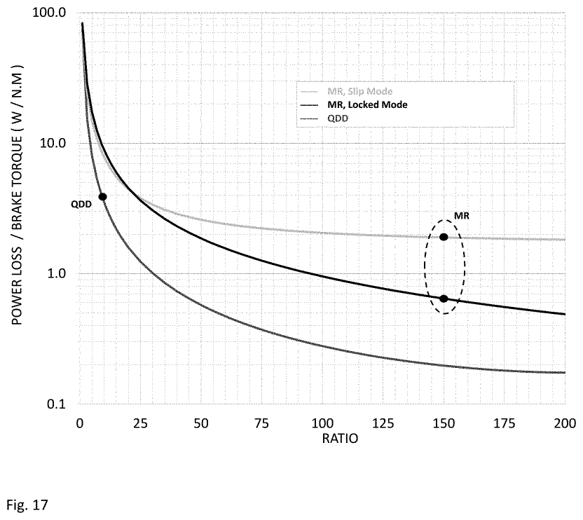

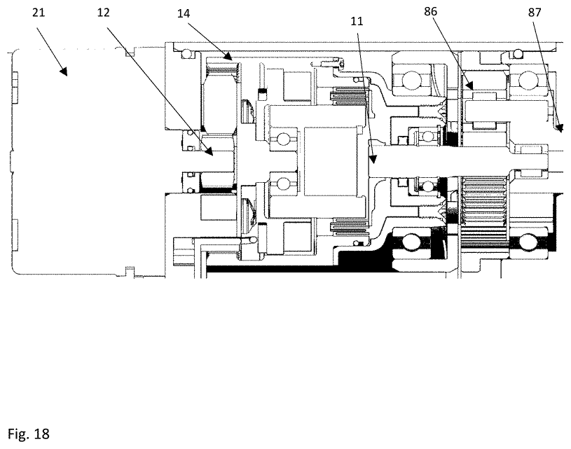

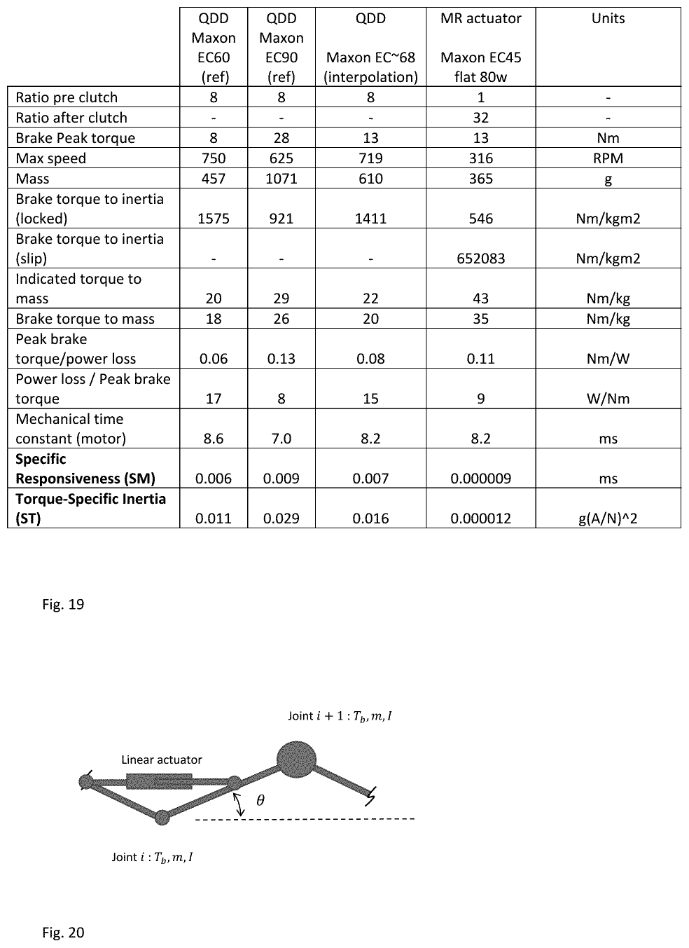

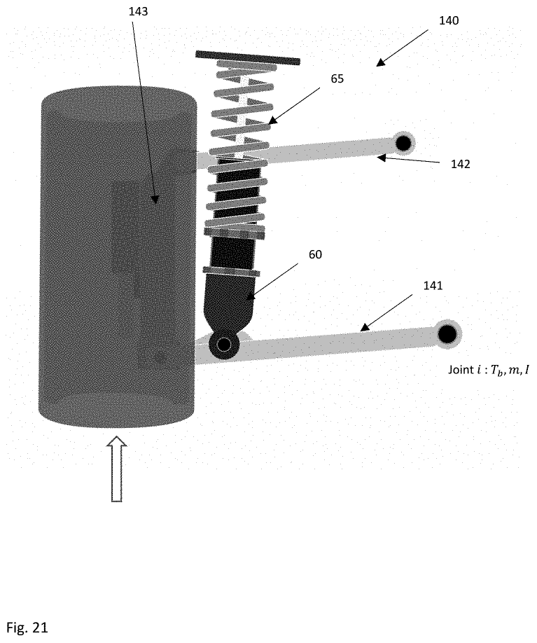

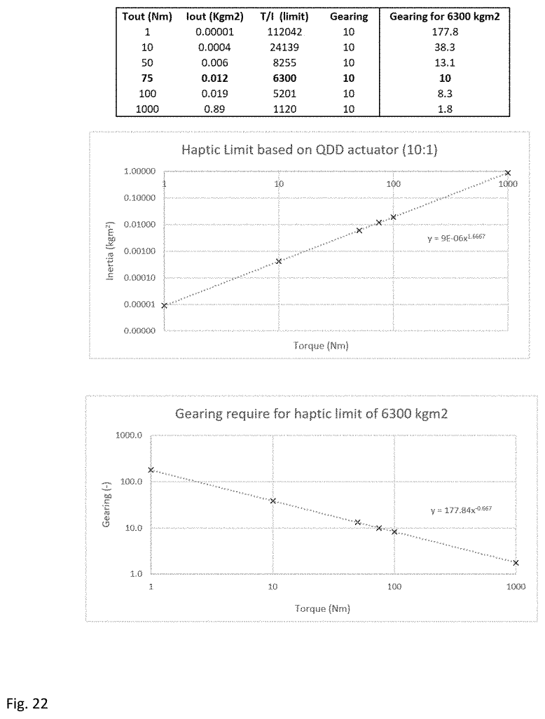

(3) Cycle-life Slope: The rechargeable lithium battery cells according to Example 1 and Comparative Example 1 were 200 times charged and discharged at 1 C at 25° C., and the results are shown in FIG. 5.

TABLE 3

| | | Characteristics of rechargeable | |
|---|---|---|---|
| | | lithium battery cells | |
| | | Initial | Long-term cycle-life |
| | Type of negative | efficiency | characteristics |
| | active material | (F.C.E, %) | (@300 cyc) |
| Comparative | Si:graphite = | 88.2 | 0 |
| Example 1 | 5:5 (blending) | | |
| Comparative | Si@a-C | 86.0 | 60.4 |
| Example 2 | | | |
| Example 1 | Si@a-C@g-C | 87.5 | 90.6 |
| Example 2 | Si@a-C@g-C | 82.8 | 91.1 |
| Example 3 | Si@a-C@g-C | 87.7 | 82.3 |
| Example 4 | Si@a-C@g-C | 88.2 | 71.5 |
| Example 5 | Si@a-C@g-C | 86.2 | 80.2 |
| Example 6 | Si@a-C@g-C | 86.1 | 79.8 |
| Example 7 | Si@a-C@g-C | 87.4 | 89.8 |

Referring to Table 3, a high weight fraction of the amount of silicon in a negative electrode composite or graphitized carbon (graphite) present at an appropriate temperature exhibited high initial efficiency. In addition, although there were efficiency changes and cycle characteristic differences according to a size of primary silicon, the composites including amorphous carbon and graphitized carbon in the proposed amounts exhibited excellent characteristics.

By way of summation and review, the non-carbon negative active material may have a large volume change due to charging and discharging, and thus cycle-life of the rechargeable lithium battery could be shortened, compared to the carbon negative active material.

One or more embodiments may provide a negative active material composite capable of simultaneously securing capacity, initial efficiency, long-term cycle-life, and the like, while preventing a sharp decline in an initial cycle-life of a rechargeable lithium battery.

The negative active material composite of an embodiment may implement a rechargeable lithium battery that exhibits excellent capacity, initial efficiency, long-term cycle-life, and the like, while a sharp decline in an initial cycle-life is prevented.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A negative active material composite for a rechargeable lithium battery, the negative active material composite comprising:
silicon nanoparticles;
amorphous carbon; and
graphitized carbon.

2. The negative active material composite as claimed in claim 1, wherein the graphitized carbon includes 2 to 20 layers of graphene.

3. The negative active material composite as claimed in claim 1, wherein:
the graphitized carbon is converted from a portion of the amorphous carbon, and
the graphitized carbon is distributed on a surface of the amorphous carbon, an inside of the amorphous carbon, or both the surface and the inside of the amorphous carbon.

4. The negative active material composite as claimed in claim 3, further comprising a catalyst.

5. The negative active material composite as claimed in claim 4, wherein the catalyst is iron (III) nitrate, nickel (II) nitrate, or a combination thereof.

6. The negative active material composite as claimed in claim 4, wherein the catalyst has an average particle diameter (D50) of greater than 0 nm and less than or equal to about 150 nm.

7. The negative active material composite as claimed in claim 1, wherein the silicon nanoparticles have an average particle diameter (D50) of about 50 nm to about 200 nm.

8. The negative active material composite as claimed in claim 1, wherein the silicon nanoparticles have an aspect ratio of about 5 to about 20.

9. The negative active material composite as claimed in claim 1, wherein, in an X-ray diffraction analysis using CuKα ray, a full width at half maximum of an X-ray diffraction angle (2θ) at the (111) plane of the silicon nanoparticles is about 0.3° to about 9°.

10. The negative active material composite as claimed in claim 1, wherein:
when analyzing a Raman shift using a photon energy difference, the negative active material composite satisfies Equation 1:
2.7≤A_{D}/A_{G}≤5 [Equation 1]
in Equation 1,
A_{D} denotes an integral area in the disordered peak, 1350 cm⁻¹ to 1360 cm⁻¹, of the graphitized carbon; and
A_{G} denotes an integral area at the alignment peak, 1580 cm⁻¹ to 1590 cm⁻¹, of the graphitized carbon.

11. The negative active material composite as claimed in claim 1, wherein the amorphous carbon includes soft carbon, hard carbon, a mesophase pitch carbonized product, calcined coke, or a mixture thereof.

12. The negative active material composite as claimed in claim 1, wherein the negative active material composite includes about 80 to 250 parts by weight of the silicon nanoparticles, based on 1 part by weight of the graphitized carbon.

13. The negative active material composite as claimed in claim 1, wherein the negative active material composite includes about 25 to 150 parts by weight of the amorphous carbon, based on 1 part by weight of the graphitized carbon.

14. The negative active material composite as claimed in claim 1, wherein the negative active material composite includes:
about 0.1 wt % to about 1 wt % of the graphitized carbon, and
about 35 wt % to about 85 wt % of the silicon nanoparticles, all wt % being based on a total weight of the negative active material composite.

15. The negative active material composite as claimed in claim 1, wherein an average particle diameter (D50) of the negative active material composite is about 2 μm to about 15 μm.

16. The negative active material composite as claimed in claim 1, wherein the negative active material composite includes:
a matrix including the amorphous carbon;
the silicon nanoparticles inside the matrix; and
the graphitized carbon distributed on a surface of the matrix, inside of the matrix, or both on the surface and inside of the matrix.

17. A method of preparing a negative active material composite for a rechargeable lithium battery, the method comprising:
spray-drying a slurry including a solvent, a catalyst, and silicon nanoparticles; and
heat-treating a mixture including the obtained product of the spray-drying and an amorphous carbon precursor to obtain a negative active material.

18. A negative electrode for a rechargeable lithium battery, the negative electrode comprising:
a current collector; and
a negative active material layer on the current collector,
wherein the negative active material layer includes the negative active material composite as claimed in claim 1.

19. The negative electrode as claimed in claim 18, wherein the negative active material layer further includes a conductive material, a binder, a negative active material that is different from the negative active material composite, or a combination thereof.

20. A rechargeable lithium battery, comprising:
a positive electrode;
a negative electrode; and
an electrolyte,
wherein the negative electrode is the negative electrode as claimed in claim 18.
